(19) United States
(12) Patent Application Publication
(10) Pub. No.: US 2008/0007830 A1
(43) Pub. Date: Jan. 10, 2008

(54) Glass photonic crystal band-gap devices with polarizing properties

(76) Inventors: Nicholas Francis Borrelli, Elmira, NY (US); Sergey Anatolyevuch Kuchinsky, St. Petersburg (RU); Karl William Koch, Elmira, NY (US); Sasha Marjanovic, Painted Post, NY (US)

Correspondence Address: CORNING INCORPORATED, SP-TI-3-1, CORNING, NY, 14831, US

(21) Appl. No.: 11/804,503

(22) Filed: May 18, 2007

Related U.S. Application Data
(60) Provisional application No. 60/818,907, filed on Jul. 6, 2006.

(51) Int. Cl. G02B 5/30; C03B 37/022; C03B 37/025; C03B 37/15

(52) U.S. Cl. 359/488; 65/401; 65/406; 65/435

(57) ABSTRACT

The invention is directed to polarizing devices that can be scaled to polarize electromagnetic radiation having wavelengths in ultraviolet to microwave range; and more particularly to devices suitable for use at visible and IR wavelengths. The device has a length, a width and a thickness, and a patterned system of channels, voids or holes embedded in or through a glass matrix and running through the thickness of the glass to thereby polarize incoming electromagnetic radiation having two polarization modes orthogonal to one another, blocking the passage of or reflecting one mode and permitting the other mode to pass through the device. The glass can be any glass suitable for transmitting the electromagnetic radiation in the range it will be used without excessive transmission losses due to absorbance of radiation in that range by moieties present in the glass. In one aspect, the device according to the invention may be deemed a “universal” polarizer: in the sense that it can be made to work in wavelength ranges from the microwave to the ultraviolet. The devices can also be made of polymeric materials utilizing the principles enumerated in the specification.

### FIELD OF THE INVENTION

The invention is directed to glass polarizing devices having a photonic band-gap structure. In particular, the invention is directed to polarizing devices that can be sized to polarize electromagnetic radiation having wavelengths in ultraviolet to microwave range; and more particularly to devices suitable for use at telecommunications wavelengths. Finally, methods of making glass polarizing devices are described.

### BACKGROUND OF THE INVENTION

Ordinary unpolarized light consists of many waves that have their electric and magnetic field randomly oriented, though the two fields are always perpendicular (orthogonal) to one another and to the direction of travel. By convention, light is considered to be a combination of two polarizations. When light is transmitted through multimode optical fibers, polarization is not important. However, when light is transmitted through a single-mode optical fiber, the polarization of the light can be important because single-mode fibers actually carry two modes that are perpendicular to one another. These two modes are functionally equivalent and their mode shape and propagation characteristics cannot be distinguished in an optical fiber having a perfectly symmetric circular core except by their polarization. However, in the real world the core is never perfectly symmetric. As a result, the time required for the two polarizations modes to travel through the fiber may be different because they experience different conditions within the core and hence propagate through it at different speeds. As a result, the light is dispersed and performance is degraded. This degradation can be avoided by polarizing the light prior to its being transmitted by the optical fiber.

A number of methods for polarizing light and maintaining its polarizations are known and have been use in telecommunications. One method has been to use a polymer film that is doped with a dichroic material. While this type of polarizer is inexpensive and easy to prepare, it is not satisfactory because its extinction ratio (which quantifies the extent to which light is polarized along one axis) is not sufficient for many application requirements. In addition, they do not perform well in the blue part of the visible spectrum or in the ultraviolet, and they do not hold up to high power (that is, their thermal stability is low). Glan-Thompson polarizers are another means of polarizing light. They are produced by joining two rectangular prisms of a material such as calcite that has a large double coefficient of refraction. However, while Glan-Thompson polarizers have a high extinction ratio and are thermally stable, producing large and/or thin polarizers of this type is very difficult, problems are encountered with the “cement” that holds the prisms together, and Glan-Thompson polarizers are very expensive. Another type of polarizer is one that utilizes the Brewster angle of a transparent body, for example, a beam splitter using a multilayer dielectric material. While this type of device is inexpensive and can be mass produced, it has limited utility and is not satisfactory in general because it is difficult to miniaturize, one cannot attain a high degree of polarization, and the wavelength band in which it can be used is narrow. Consequently, in view of the problems associated with polarizers that are presently available, there is need for a polarizer that is relatively inexpensive to manufacture, is highly durable, has a high extinction (contrast) ratio, polarizes over a wide range of wavelengths, and can stand up to high power (for example, lasers and high intensity lamps in projectors).

### SUMMARY OF THE INVENTION

The invention is directed to a glass device capable of polarizing electromagnetic radiation, the device having a length, a width and a thickness, and a patterned system of channels, voids or holes embedded in or through a glass matrix and running through the thickness of the glass to thereby polarize incoming electromagnetic radiation having two polarization modes orthogonal to one another, blocking the passage of or reflecting one mode and permitting the other mode to pass through the device. The device of the invention can be tailored to operate at wavelengths varying from the microwave to the ultraviolet in the electromagnetic radiation spectrum (wavelengths λ in the range of approximately 10 to 10⁻⁷ centimeters, respectively). The glass can be any glass suitable for transmitting the electromagnetic radiation in the range it will be used without excessive transmission losses due to absorbance of radiation in that range by moieties present in the glass. In one aspect, the device according to the invention may be deemed a “universal” polarizer in the sense that it can be made to work in wavelength ranges from the microwave to the ultraviolet. Once the dimensions of the polarizer are fixed (particularly thickness and the dimensions of the channels, holes or voids therein) you have fixed the wavelength at which the polarizer will operate (that is, the wavelength of the light that will be polarized). The channels can have a size in the approximate range of range of 200 to 2200 nm. For example, in the visible range the “channels” have a size of in the approximate range of 400-500 nm and in the ultraviolet range the “channels” have a size in the approximate range of 220-280 nm. In the infrared the “channels or holes” will have a size in the approximate range of 1000 to 2000 nm. The device(s) according to the invention can also be made of polymeric materials by utilizing the principles enumerated herein.

In one embodiment the glass device is an glass polarizer capable of polarizing light in the infrared (“IR”) and visible ranges of the electromagnetic spectrum, approximately 10⁻² cm to 7×10⁻⁵ cm for the infrared range and approximately 7×10⁻⁵ to 4×10⁻⁵ cm for the visible range, said device having a length, width and thickness. The devices have a system of regular parallel channels, voids or holes embedded in a glass matrix and running through the thickness of the glass. The channels of the device are circular in shape and have a selected diameter and spacing suitable for the light range in which the polarizer will be applied.

In another embodiment the device is a glass polarizer suitable for use at the optical telecommunication wavelengths of approximately 700-1600 nm. The polarizer has a system of regular parallel channels, voids or holes embedded in a glass matrix and running through the thickness of the glass. The channels of the device are circular in shape and have a selected diameter and spacing suitable for the light range in which the polarizer will be applied.

In another embodiment a method of making a glass polarizer capable of polarizing light in IR and visible ranges of the electromagnetic spectrum, is described. Glass plates of various thicknesses, ranging from 100 microns to several millimeters, preferably 200-900 microns, are used to drill holes according to FIG. 8, which is an integral part of the invention. Holes are drilled to make arrays of air holes in glass. Drilling is typically conducted by CO₂ laser, although other methods of drilling can be used. Glasses that can be used include high purity fused silica (HPFS), Vycor, ultra-low expansion (ULE) glass, or any other glass that will not crack under laser or conventional drilling due to stresses that are induced during the drilling process. The limitations on the glass are dictated by the specific application and the wavelengths at which the glass polarizer according to the invention will be used. For example, for optical communications uses, a glass with low hydroxyl (—OH) content is preferred because hydroxyl groups are strongly absorbing at telecommunications wavelengths.

The dimension (size or magnitude) of the holes or channels, pitch and glass plates are given in the specification. For those skilled in the art, it is clear that dimensions can vary and that it is the hole radius, pitch and the structural symmetry of the holes that determine the polarizing capabilities of the photonic bandgap structures. To make the photonic polarizer many glass plates are stacked together and fused together to make an object that is later redrawn to reduce the dimensions of the holes to dimensions needed for a particular polarization. The redraw is carried out at or about the softening point temperature of the glass that is being used. When the plates are stacked together and fused, care is taken so that within the stack the air holes of one glass a glass plate fall on top of the air holes of adjacent glass plates to make vertical cylindrical air channels or holes within the stacked glass plates and any object formed by fusion of the stack of plates. Structural symmetry of air holes is preserved within structure, making an object that appears to be a tall glass block with, for example, cylindrical air holes from top to bottom in the same structural symmetry as a glass plate from FIG. 8. Looking from the top, such object appears exactly like a glass plate as illustrated in, for example, FIG. 8. The height of the object can vary and it is at least several centimeters. This is important since the glass object is later redrawn to reduce the dimensions of air holes to desired ones for a particular wavelength. For example, if polarization in blue visible electromagnetic region is needed, the spacing of the holes should be approximately 200 to 250 nm.

### BRIEF DESCRIPTION OF THE DRAWINGS

FIG. 1 is an illustration of the concept of the invention showing a structure with a series of regular “channels” to polarize light.

FIG. 2 illustrates a photonic crystal and shows how an incident beam of non-polarized light suffers refraction at considerable angles as it passes through the photonic crystal.

FIG. 3 illustrates the physical locations that are used to determine the values 2r and Λ used in the equations given herein.

FIG. 4 illustrates the angle between transverse-electric, TE and transverse-magnetic, TM wave Poynting vectors as a function of incident angle for two different photonic crystal structures.

FIG. 5 illustrates the band edge frequencies for a series of hole-radius-to-pitch ratios, the two curves representing the top and bottom of the band gap for a TE polarized wave.

FIG. 6 illustrates the wavelength of the band edges as a function of channel using an exemplary pitch of 250 nm.

FIG. 7 illustrates the normalized gap as a function of hole-radius-to-pitch ratio for a plate having holes drilled with a selected radius, pitch and structural symmetry.

FIG. 8 illustrates a plate with holes drilled to a selected radius (illustrated as diameter 2r), pitch and structural symmetry.

### DETAILED DESCRIPTION OF THE INVENTION

As used herein the term radius means one-half the diameter of a circular channel or one-half the distance of the largest dimension of a non-circular channel (e.g., a rectangular, square, octagonal, trapezoidal or other shaped channel). As also used herein the terms “holes”, “channels” and “openings” may be used interchangeably.

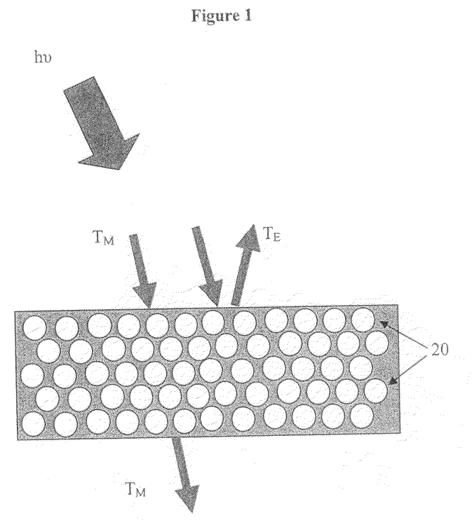

FIG. 1 illustrates a photonic crystal structure having a regular series of parallel channels through the thickness that create band gaps which are spectral bands where the propagation of light in certain directions is forbidden. Photonic band gaps are different for different polarizations of light and there are spectral bands where light of only one polarization can propagate and the light of the other polarization is completely reflected. If the working wavelength of light is in one of these spectral bands then the photonic crystal can work as a polarizer. Incident light hυ is polarized such that the TM polarized light passes through (is propagated) and the TE polarized light is completely reflected. Transverse electric (“TE”) fields, as exemplified using the illustrated photonic crystal consisting of a series of parallel cylindrical channels or holes, are electromagnetic fields with their electric field component polarized perpendicular to the axes of the channels. The transverse magnetic (“TM”) fields are those whose electric field component is polarized parallel to the axes of the channels.

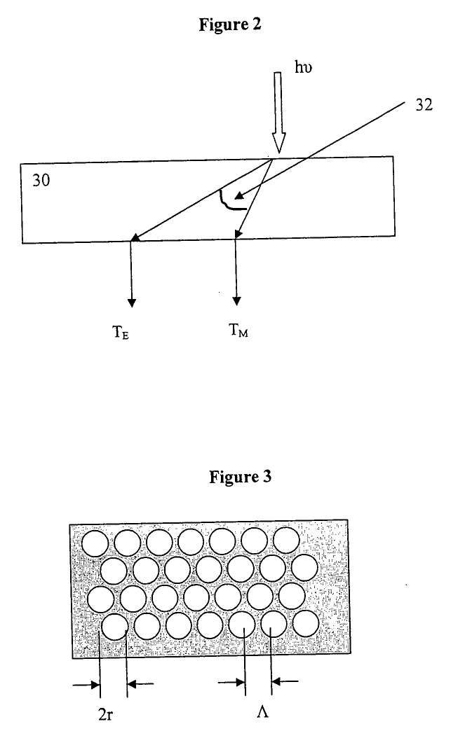

FIG. 2 illustrates the implementation of polarization splitting based on birefringence of glass photonic crystals at a wavelength in the transmission window for both polarizations. Incident light hi) strikes a photonic crystal 30 and the TM and TE polarization components of the impinging beam are redirected at considerable angles as shown by 32. Using modeling based on the plane-wave expansion method, it has been determined that for a wavelength of 1.5 μm the angular separation of the two polarization components can be as much as 15 degrees.

FIG. 3 illustrates the geometrical parameters for a glass photonic crystal providing the same polarization separation (˜15 degrees) at a visible wavelength λᵥ, can be determined using the electrodynamic scaling relationships

2rᵥ=2rλᵥ÷λ_{IR} and Λᵥ=Λλᵥ÷λ_{IR}

where 2rᵥ and 2r are the diameters of air channels for visible and infrared (“IR”) wavelengths, respectively (λ_{IR}=1.5 μm); and Λᵥ and Λ are the pitches of a 2D lattice for the visible and IR wavelength, respectively. The structure according to the invention that is illustrated in FIG. 3 provides the same degree of separation as that illustrated in FIG. 2; the photonic structure having pitch Λ=1.25 μm, channel radius r=0.5 μm, a working wavelength λ=1.5 μm.

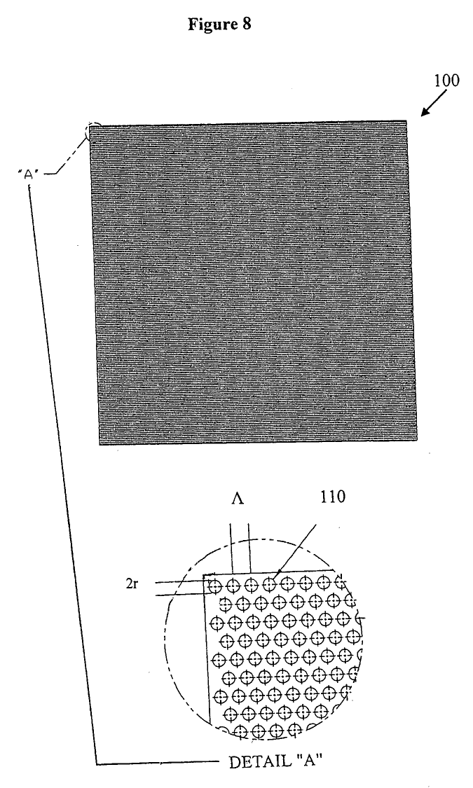

FIG. 8 illustrates a large plate 100, in this case one with a length×width×thickness (L×W×T) of 50.8 mm×50.8 mm×2 mm, that can be used as is or sectioned onto smaller plates if desired and Detail A from the plate. Detail A shows the structural geometry of the plate, the diameter of the holes 110 which are illustrated as 2× radius (i.e., 2r), and the pitch Λ. The plates are not limited to the foregoing L×W×T, but can be of any size suitable for the manufacturing process and the application. The radius of the holes, the pitch and the geometry can also be changed in accordance with the teachings herein. Once plates such as that illustrated in FIG. 8 are manufactured, a plurality of these plates are stacked together and heated to a selected temperature, typically a temperature approximately equal to the softening point of the glass so that the plates fuse together while maintaining their channel structure. The fused stack of plates is then subjected to a redraw process as described in this specification.

The dimension (size or magnitude) of the holes or channels, pitch and glass plates are given in the specification. For those skilled in the art, it is clear that dimensions can vary and that it is the hole radius, pitch and the structural symmetry of the holes that determine the polarizing capabilities of photonic bandgap structures. To make the photonic polarizer many glass plates are stacked together and fused together to make an object that is later redrawn to reduce the dimensions of the holes to dimensions needed for a particular polarization. The redraw is carried out at or about the softening point temperature of the glass that is being used. When the plates are stacked together and fused, care is taken so that within the stack the air holes of one glass a glass plate fall on top of the air holes of adjacent glass plates to make vertical cylindrical air channels or within the stacked glass plates and any object formed by fusion of the stack of plates. Structural symmetry of air holes is preserved within structure, making an object that appears to be a tall glass block with cylindrical air holes from top to bottom in the same structural symmetry as a glass plate from FIG. 8. Looking from the top, such object appears exactly like a glass plate illustrated in FIG. 8. The height of the object can vary and it is at least several centimeters. This is important since the glass object is later redrawn to reduce the dimensions of air holes to desired ones for a particular wavelength. For example, if polarization in blue visible electromagnetic region is needed, the spacing of the holes should be approximately 200 to 250 nm.

The polarizer according to the invention comprises a channeled glass plate having a selected length and a width, and a thickness of greater than or equal to 18Λ, where the period of the 2D lattice Λ is approximately 0.4 μm. Preferably the thickness is in the range of 18-22Λ. Preferably the channeled glass plate has a selected length and a selected width, and a thickness of greater than or equal to 20 Λ, where the 2D lattice Λ is approximately 0.4 μm. The glass plate can be made of any optical glass that is suitable for the transmission of light at the wavelength at which the polarizing device according to the invention is going to be used. The channeled glass plate can be manufactured by any suitable method known in the art; the preferred methods being by extrusion and by stack-and-draw (that is, stacking a groups of hollow fibers or capillaries together and drawing them down such that the hollow channels or openings in each fiber or capillary attains the desired channel diameter and the fibers are fused together). Examples of such glass, without limitation, include fused silica, fluorine-doped fused silica, high purity fused silica (for example, HPFS® from Corning Incorporated), borosilicate glass, Pyrex® glass and other glasses known in the art useful for making polarizers. The limitations on the glass are dictated by the specific application and the wavelengths at which the glass polarizer according to the invention will be used. For example, for optical communications uses, a glass with low hydroxyl (—OH) content is preferred because hydroxyl groups are strongly absorbing at telecommunications wavelengths. The selected length and width of the glass plate made from the glass material is not limited, but can be any size suitable for the manufacturing process and the application. By way of example, without limitation, FIG. 8 illustrates a plate whose length and width are each 50.8 mm. As desired, larger or smaller plates can be made.

The advantages of the polarizing device according to the invention is that it is very durable since it is an all-glass structure; being made of glass it is very stable regarding temperature variations due to the low coefficient of thermal expansion possessed by glass; there is substantially no optical absorption; and one can make a polarizer for red, green and blue wavelengths because the 2D lattice structure is the same for each—the only differences being in the pitch Λ and air channel diameter 2r.

A number of factors of importance for a polarizer based on an optical crystal device include spectral sensitivity, angular sensitivity, reflection losses of the transmitted polarization, and the minimal thickness of the glass plate that is sufficient for reflection of one polarization of the reasonable separation of two different polarizations. Studies of these factors have resulted in a polarizer that is angularly insensitive.

The following Table 1 describes the tolerances for an angularly sensitive polarizer. The Fresnel losses of the transmitted polarization estimated by examining the effective index n_{eff} of the structure for the transmitted polarization at the angles of operation. We find the effective index of the structure for r/Λ=0.35 is n_{eff}=1.12 and for r/Λ=0.49 is n_{eff}=0.92; these result in Fresnel reflections of 0.3% and 0.2%, respectively, implying transmissions of 99.4% and 99.6%.

In optics, Fresnel reflection is the reflection of a portion of incident light at a discrete interface between two media having different refractive indices, for example, glass and air. Fresnel reflection occurs at the air-glass interfaces at the entrance and exit ends of, for example, an optical fiber. The resultant transmission losses, on the order of 4% per interface, can be reduced considerably by the use of index-matching materials. The coefficient of reflection depends upon the refractive index difference, the angle of incidence, and the polarization of the incident radiation. For a normal ray, the fraction of reflected incident power is given by the equation

$$R {{=}_{a .}}^{a .} \frac{{( {n}_{1} - {n}_{2} )}^{2}}{{( {n}_{1} + {n}_{2} )}^{2}} \qquad 2.$$

where R is the power reflection coefficient and n₁ and n₂ are the respective refractive indices of the two media. In general, the greater the angles of incidence with respect to the normal, the greater the Fresnel reflection coefficient; but for radiation that is linearly polarized in the plane of incidence, there is zero reflection at Brewster's angle.

TABLE 1

| | | | | | Spectral | |
|---|---|---|---|---|---|---|
| | | | Λ for | Pitch | Accept- | Angular |
| | | | λ = 500 nm | Tolerance | ance | Sensitivity |
| r/Λ | Λ/λ | Δ(Λ/λ) | (1064 nm) | (nm) | (nm) | (degrees) |
| 0.35 | 0.43 | ±2 × 10⁻³ | 215.5 | ±1 | ±2.32 | ±5.5 |
| | | | (458.6) | (±2.1) | (±4.9) | |
| 0.49 | 0.53 | ±5 × 10⁻³ | 265 | ±2.5 | ±4.7 | ±8 |
| | | | (564) | (±5.3) | (±10) | |

r = radius of the channel
Λ = the pitch
λ = incident light wavelength
Λ/λ = normalized frequency
r/Λ = channel-radius-to-pitch ratio

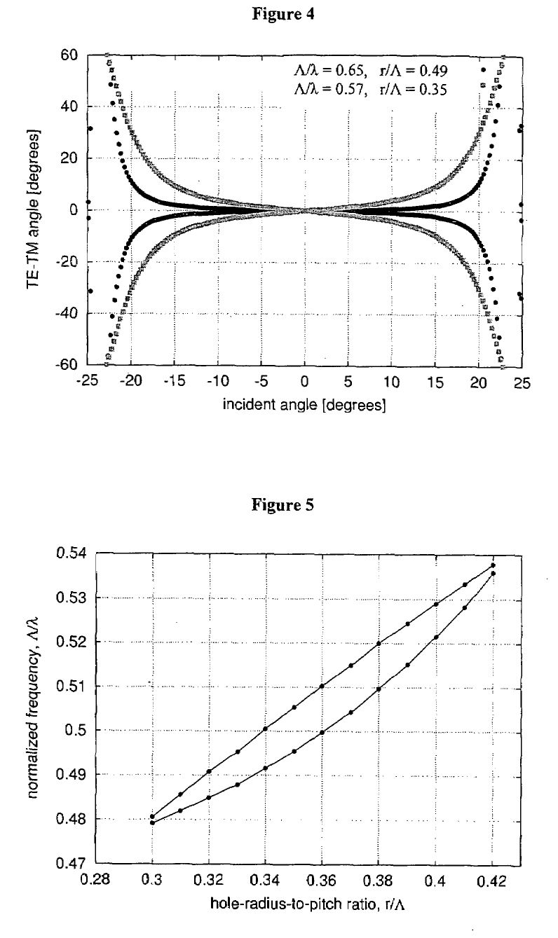

FIG. 4 is a graph illustrating the difference in angle between the TE and TM polarized Poynting vectors inside the material as a function of the incident angle for two cases of r/Λ of the photonic crystal structure. The graph indicates that for a normalized frequency, Λ/π=0.57 and a structure with r/Λ=0.35, the two Poynting vectors corresponding to the two polarizations (TE and TM) will separate at an angle of 20°. Thus, to achieve a separation of 125 μm at the output of the photonic crystal structure, the thickness of the photonic crystal structure needs to be approximately 350 μm.

We have discovered that one can make an angularly insensitive polarizer. We have found a band gap for all angles in the plane of periodicity for the TE polarization in a triangular lattice of air channels in a glass or silica matrix. This band gap can be utilized in the construction of the angularly insensitive polarizer. The relevant values for the size of the channels and values for the normalized frequency are illustrated in FIG. 5. The two curves shown in FIG. 5 represent the top and bottom of the band gap for the TE polarized light wave.

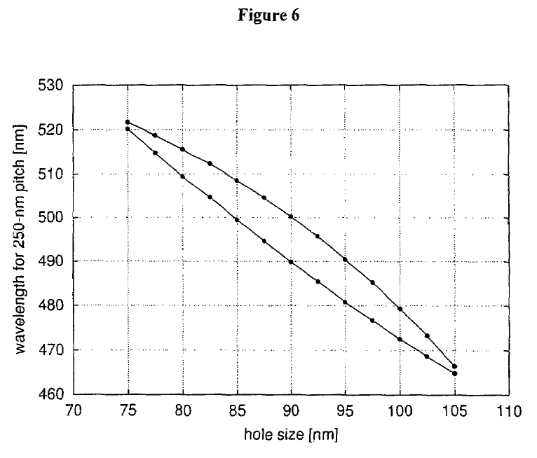

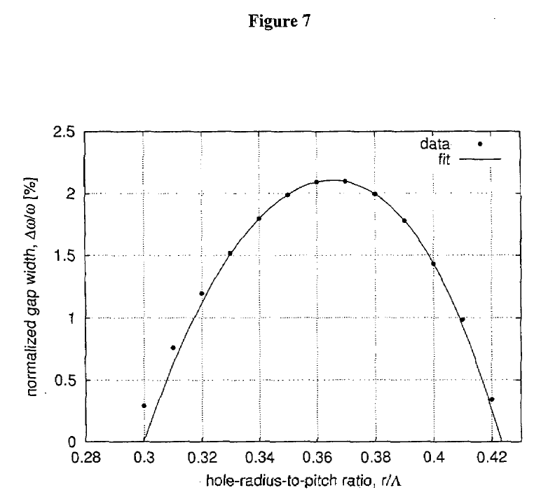

By way of example, FIG. 6 illustrates a photonic structure with a 250 nm pitch. The graph illustrates the wavelengths and channel-size sensitivity for the device. For a polarizer operating at a wavelength of 500 nm, the structure would tolerate channel sizes in the range of 85-90 nm. If the channel size was specifically, for example, 87.5 nm, the polarizing wavelength range of the device would be from 495 nm to 505 nm. The spectral sensitivity Δλ/λ and structural sensitivity ΔΛ/Λ are illustrated in FIG. 7, and the tolerances for the device are shown in Table 2.

TABLE 2

| | | | | Pitch | Spectral | |
|---|---|---|---|---|---|---|
| | | | Λ for | Toler- | Accept- | Angular |
| | | | λ = 500 nm | ance | ance | Sensitivity |
| r/Λ | Λ/λ | Δ(Λ/λ) | (1064 nm) | (nm) | (nm) | (degrees) |
| 0.36 | 0.505 | ±2 × 10⁻³ | 253 | ±1 | ±2.32 | ±180 |
| | | | (537) | (±11) | (±21) | |

Thus, using the device as illustrated by FIG. 7 and Table 2, one would obtain a polarizer in which two polarizations impinge on the device at the same angle: one polarization sees no modes available for propagation through the device; and the other polarization propagates through the device and exits the other side.

A method of making a glass polarizer capable of polarizing light in IR and visible ranges of the electromagnetic spectrum is described. Glass plates of various thicknesses, ranging from 100 microns to several millimeters, preferably 200-900 microns, are used to make the glass polarizer and channels or holed are drilled or otherwise formed in the plates (see FIG. 8), the channels or holes being an integral part of the invention. Holes are drilled to make arrays of air holes in glass. Drilling is typically conducted by CO₂ laser, although other methods of drilling can be used. Glass can be that of high purity fused silica (HPFS), Vycor, ultra-low expansion (ULE) glass, or any other glass that will not crack under laser or conventional drilling due to stresses that are induced during the drilling process. The height of the object can vary and it is at least several centimeters. This is important since the glass object is later redrawn to reduce the dimensions of air holes to desired ones for a particular wavelength. For example, if polarization in the blue visible electromagnetic spectrum is needed, dimensions of the air holes and the pitch within should be in the order of hundreds of nanometers. This is achieved by redrawing an object made of stacked plates as illustrated in FIG. 8, making channels with the radius and the pitch in the order of hundreds of nanometers.

While the invention has been described with respect to a limited number of embodiments, those skilled in the art, having benefit of this disclosure, will appreciate that other embodiments can be devised which do not depart from the scope of the invention as disclosed herein. For example, the glass device described herein can also be made of polymeric materials by utilizing the principles enumerated herein. Accordingly, the scope of the invention should be limited only by the attached claims.

We claim:

1. An optical polarizer based on photonic crystal principles, said polarizer having a periodic variation of refractive index n within the structure of the polarizer such that electromagnetic radiation of wavelength λ entering the polarizer is polarized into its two polarization components TM and TE, the TM component being allowed to pass through the polarizer and the TE component being reflected.

2. The optical polarizer according to claim 1, wherein the polarizer comprising a dielectric material transparent to the selected wavelength λ and having a selected thickness and a plurality of channels having a length through the dielectric material;
wherein said plurality of channels have a pitch Λ and the wavelength λ enters and passes through the polarizer in a direction transverse to the length of the channels; and
wherein the thickness is defined by a plurality of rows of channels.

3. The polarizer according to claim 2, wherein the dielectric material is selected from the group consisting of glass and polymeric materials that are transparent to the electromagnetic radiation of wavelength λ

4. The device according to claim 1, wherein the thickness of is equal to or greater than 18Λ.

5. The device according to claim 1, wherein the device has a band gap that is a function of normalized frequency Λ/λ and channel-radius-to-pitch ratio r/Λ; said channels having a pitch in the range of 0.2-0.6 μm and a selected channel size.

6. The device according to claim 1, wherein the dielectric material is selected from the group consisting of silica glass, fused silica glass, fluorine-doped fuse silica glass, high purity fused silica, ultra-low expansion glass having a CTE of 0±30 ppb/° C., and borosilicate glass.

7. The device according to claim 1, wherein said device polarizes electromagnetic radiation having wavelengths in the microwave to ultraviolet range, the exact wavelength at which the device polarizes said radiation being determined by selection of r and Λ.

8. The device according to claim 1, wherein said device polarizes electromagnetic radiation having wavelengths in the green, blue and red portions of the spectrum, the exact wavelength being polarized being dependent on the selected values of r and Λ.

9. A visible light polarizer comprising a dielectric material having a selected length and a selected width, each of which is independently chosen in the range of 0.4 mm to 0.6 mm, a thickness in the range of 18-22Λ and plurality of air-filled channels through the thickness of the glass,
wherein said channels have a selected radius and pitch Λ in the range of 0.2-0.6 μm.

10. The polarizer according to claim 9, wherein said polarizer polarizes light at blue, red and green wavelengths.

11. The polarizer according to claim 9, wherein the dielectric material is selected from the group consisting of silica glass, fused silica glass, fluorine-doped fused silica glass, high purity fused silica, ultra-low expansion glass having a CTE of 0±30 ppb/° C., and borosilicate glass.

12. A method for making a glass polarizer having a photonic structure, said method comprising
providing a selected glass composition, and
extruding the selected glass into a shape having a selected length and a selected width, and a thickness in the range of 18-22Λ, and plurality of air-filled channels through the thickness of the glass,
wherein the channels have a selected radius r and pitch Λ in the range of 0.2-0.6 μm.

13. The method according to claim 12, wherein the provided glass is selected from the group consisting of silica glass, fused silica glass, fluorine-doped fuse silica glass, high purity fused silica, ultra-low expansion glass having a CTE of 0±30 ppb/° C., and borosilicate glass.

14. A method of making a glass polarizer having a photonic structure, said method comprising:
providing a glass plate made of a selected glass;
drilling a plurality of channels having a structural symmetry into said plate;
stacking a plurality of plates together such that the channels within the plates are aligned,
fusing the plates together, and
redrawing the stack of plates such that the structural symmetry of the channels are preserved during the redraw process in which the diameter of the channels is narrowed to a selected diameter in the range of 200 to 2200 nm during the redraw process;
wherein the diameter of the channels after redraw are in the range of 200 to 2200 nm, and the thickness of the polarizer is in the range of 18-22Λ and the pitch Λ is in the range of 0.2 to 0.6 μm.

15. The method according to claim 14, wherein the provided glass is selected from the group consisting of silica glass, fused silica glass, fluorine-doped fuse silica glass, high purity fused silica, ultra-low expansion glass having a CTE of 0±30 ppb/° C., and borosilicate glass.

16. A method of making a glass polarizer having a photonic structure, said method comprising:
providing a stack of plurality of hollow fibers or capillaries each having an channel of a selected diameter therethrough,
redrawing the stack of hollow filers or capillaries such that during the redraw process the fibers or capillaries are fused together and structural symmetry of the channels within the stack of fibers or capillaries is preserved during the redraw process in which the diameter of the channels is narrowed to a selected diameter in the range of 200 to 2200 nm during the redraw process;
wherein the diameter of the channels after redraw are in the range of 200 to 2200 nm, and the thickness of the polarizer is in the range of 18-22Λ and the pitch Λ is in the range of 0.2 to 0.6 μm.

17. The method according to claim 16, wherein the provided glass is selected from the group consisting of silica glass, fused silica glass, fluorine-doped fuse silica glass, high purity fused silica, ultra-low expansion glass having a CTE of 0±30 ppb/° C., and borosilicate glass.
